(19) United States
(12) Patent Application Publication
(10) Pub. No.: US 2016/0064738 A1
(43) Pub. Date: Mar. 3, 2016

(54) NONAQUEOUS ELECTROLYTE SECONDARY BATTERY

(71) Applicant: SANYO ELECTRIC CO., LTD., Daito-shi, Osaka (JP)

(72) Inventors: Takatoshi Higuchi, Hyogo (JP); Fumiharu Niina, Hyogo (JP); Daisuke Nishide, Hyogo (JP); Hiroyuki Fujimoto, Osaka (JP)

(73) Assignee: SANYO ELECTRIC CO., LTD., Daito-shi, Osaka (JP)

(21) Appl. No.: 14/779,888

(22) PCT Filed: Mar. 20, 2014
(86) PCT No.: PCT/JP2014/001625

§ 371 Date: Sep. 24, 2015

(30) Foreign Application Priority Data
Mar. 29, 2013 (JP) 2013-072668

(51) Int. Cl. H01M 4/62; H01M 4/525; H01M 4/505; H01M 10/0567; H01M 10/0525

(52) U.S. Cl. CPC H01M 4/628; H01M 10/0567; H01M 10/0525; H01M 4/505; H01M 4/525; H01M 2220/30; H01M 2220/20

(57) ABSTRACT

An aspect of the invention resides in a nonaqueous electrolyte secondary battery (10) including a positive electrode (11), a negative electrode (12) and a nonaqueous electrolytic solution, the positive electrode including a positive electrode active material containing a lithium transition metal oxide having a rare earth compound attached on the surface, the nonaqueous electrolytic solution including an aromatic compound having an oxidative decomposition potential in the range of 4.2 to 5.0 V vs. Li/Li⁺. The rare earth compound is preferably a rare earth hydroxide, a rare earth oxyhydroxide or a rare earth oxide.

### TECHNICAL FIELD

The present invention relates to nonaqueous electrolyte secondary batteries.

### BACKGROUND ART

In recent years, mobile devices such as cellular phones including smartphones and notebook computers have become markedly smaller and more lightweight. Further, the expansion of their functions has led to an increase in power consumption. As a result, there have been increasing demands that secondary batteries used as power supplies in these devices have smaller weight and higher capacity. On the other hand, electric vehicles (EVs) having no internal combustion engines, and hybrid electric vehicles (HEVs, PHEVs) running on a combination of an internal combustion engine and an electric motor have been developed to address the environmental problems associated with exhaust gas emissions from automobiles.

While nickel-hydrogen batteries are conventional power supplies widely used in the above applications, studies have been carried out to replace them by nonaqueous electrolyte secondary batteries having higher capacity and higher output. In particular, power supplies for driving electric tools, EVs, HEVs and PHEVs are required not only to have high capacity and high output but also to have small changes in internal resistance during long use.

A known technique to increase the capacity of nonaqueous electrolyte secondary batteries is to expand the range of service voltages by raising the charging voltage. However, raising the charging voltage is accompanied by an increase in the oxidation power of positive electrode active materials. Because of this and also the fact that positive electrode active materials contain catalytic transition metals (such as, for example, Co, Mn, Ni and Fe), reactions such as the decomposition of an electrolytic solution take place on the surface of the positive electrode active material. Consequently, a film that inhibits charging and discharging is formed on the surface of the positive electrode active material, and the battery increases the internal resistance and decreases the output.

To address such problems, for example, Patent Literature 1 listed later proposes a nonaqueous electrolyte secondary battery in which an oxide of a rare earth element such as Gd is disposed on the surface of positive electrode active material particles capable of storing and releasing lithium ions, and thereby the increase in charging current in the course of storage during constant voltage continuous charging (float charging) at a high potential is suppressed, that is, the reaction between a nonaqueous electrolytic solution and the positive electrode active material is suppressed.

Because nonaqueous electrolyte secondary batteries such as lithium secondary batteries have a higher energy density than other types of secondary batteries, safety insurance is of greater importance. In particular, both positive and negative electrodes in an overcharged battery are thermally instable as a result of the excessive extraction of lithium from the positive electrode and the excessive insertion of lithium into the negative electrode. As a result, drastic exothermic reaction may occur between the positive or negative electrode and a nonaqueous electrolytic solution to generate heat in the battery. Thus, the batteries have safety problems.

For example, Patent Literature 2 listed later proposes that a small amount of an aromatic compound is added as an additive to a nonaqueous electrolytic solution. In the event that the battery voltage reaches or exceeds the maximum operating voltage of the battery during charging, the aromatic compound is reacted to generate gas and to form a polymer on the surface of a positive electrode active material, and thereby the overcharging current is consumed and the battery is protected.

### CITATION LIST

### Patent Literature

PTL 1: WO 2005/008812

PTL 2: Japanese Patent No. 3113652

### SUMMARY OF INVENTION

### Technical Problem

In Patent Literature 1, an oxide of a rare earth element such as Gd is disposed on the surface of positive electrode active material particles. However, the battery significantly increases internal resistance after storage during constant voltage continuous charging and is still susceptible to improvement in the ability of maintaining the output after storage during constant voltage continuous charging. The addition of an aromatic compound disclosed in Patent Literature 2 enhances safety during overcharging but also results in a decrease in the retention of discharge capacity after charging storage as shown in Table 1, that is, a decrease in charging storage characteristics is caused.

### Solution to Problem

An aspect of the present invention resides in a nonaqueous electrolyte secondary battery which includes a positive electrode, a negative electrode and a nonaqueous electrolytic solution, the positive electrode including a positive electrode active material containing a lithium transition metal oxide having a rare earth compound attached on the surface, the nonaqueous electrolytic solution including an aromatic compound having an oxidative decomposition potential in the range of 4.2 to 5.0 V vs. Li/Li⁺.

### Advantageous Effects of Invention

The nonaqueous electrolyte secondary battery according to an aspect of the present invention prevents an increase in internal resistance after storage during constant voltage continuous charging.

### BRIEF DESCRIPTION OF DRAWING

FIG. 1 is a perspective view illustrating a longitudinal cross section of a cylindrical nonaqueous electrolyte secondary battery common to all the experiment examples.

### DESCRIPTION OF EMBODIMENTS

Hereinbelow, embodiments for carrying out the present invention will be described in detail with respect to various experiment examples. The experiment examples described below are a concrete illustration of the technical idea of the invention and do not intend to limit the scope of the invention thereto. The present invention is applicable equally to various modifications that are made without departing from the technical idea described in the claims.

### EXPERIMENT EXAMPLE 1

Hereinbelow, there will be described a specific method for producing a nonaqueous electrolyte secondary battery of Experiment Example 1 of the invention.

### [Preparation of Positive Electrode Plate]

[Ni_{0.35}Mn_{0.30}Co_{0.35}](OH)₂ prepared by a coprecipitation method and Li₂CO₃ were mixed together in a prescribed ratio and the mixture was heated at 900° C. to form lithium nickel cobalt manganese composite oxide represented by Li_{1.06}Ni_{0.33}Mn_{0.28}Co_{0.33}O₂. 1000 g of the lithium nickel cobalt manganese composite oxide particles were added to 3 L of pure water, and the mixture was stirred. Next, a solution of 4.58 g of erbium nitrate pentahydrate was added thereto together with an appropriate amount of a 10 mass % aqueous sodium hydroxide solution so that the solution containing the lithium nickel cobalt manganese composite oxide would have a pH of 9. Next, the liquid was suction filtered, and the residue was washed with water and was dried by heat treatment in the air at 300° C. for 5 hours to give a powder of lithium nickel cobalt manganese composite oxide uniformly coated with deposits of erbium oxyhydroxide. The amount of the deposits of erbium oxyhydroxide in terms of erbium element was 0.1 mol % relative to the total moles of the transition metals in the lithium nickel cobalt manganese composite oxide.

A mixture was prepared which contained 92 parts by mass of a positive electrode active material that included the erbium oxyhydroxide-coated lithium nickel cobalt manganese composite oxide prepared above, 5 parts by mass of carbon black as a conductive agent and 3 parts by mass of a polyvinylidene fluoride (PVdF) powder as a binder. The mixture was mixed together with an N-methylpyrrolidone (NMP) solution to give a positive electrode mixture slurry. Next, the positive electrode mixture slurry was applied to both sides of an aluminum foil (thickness 15 μm) as a positive electrode current collector to form positive electrode mixture layers on both sides of the positive electrode current collector. After the layers were dried, the assembly was rolled with a compression roller. Thereafter, a positive electrode tab made of aluminum was welded to an exposed portion of the positive electrode core. A positive electrode plate was thus prepared.

### [Preparation of Negative Electrode Plate]

A negative electrode plate 13 was prepared as follows. A graphite powder was used as a negative electrode active material. The graphite powder was added to a solution of CMC (carboxymethyl cellulose) as a thickening agent in water, and these were mixed together by stirring. Thereafter, styrene butadiene rubber (SBR) (styrene:butadiene=1:1) as a binder was mixed therewith to give a negative electrode mixture slurry. The mass ratio of the graphite to CMC and SBR was 98:1:1. The negative electrode mixture slurry was applied to both sides of a copper foil (thickness 10 μm) as a negative electrode current collector to form negative electrode mixture layers on both sides of the negative electrode current collector. After the layers were dried, the assembly was rolled with a compression roller. Next, a negative electrode tab made of a copper-nickel clad material was welded to an exposed portion of the negative electrode core. A negative electrode plate was thus prepared.

### [Preparation of Nonaqueous Electrolytic Solution]

A solvent was prepared by mixing ethylene carbonate (EC), methyl ethyl carbonate (MEC) and dimethyl carbonate (DMC) in a volume ratio of 30:30:40, respectively. Into the solvent prepared, LiPF₆ as a supporting salt was dissolved in 1 mol/L, and further LiBOB was dissolved in 0.1 mol/L. Thereafter, 1 mass % of vinylene carbonate was added, and 4 mass % of cyclohexylbenzene (CHB) as an aromatic compound was added. A nonaqueous electrolytic solution was thus prepared. The electrolytic solution was evaluated by a potential scanning test at 25° C. using an electrochemical cell which had a platinum electrode as the working electrode, and Li metal as the reference electrode and the counter electrode. The oxidative decomposition current started to increase sharply at about 4.65 V vs. Li/Li⁺ and thereby the oxidative decomposition potential for CHB was determined to be about 4.65 V vs. Li/Li⁺. In the absence of CHB (a nonaqueous electrolytic solution used in Experiment Example 3 described later), a sharp increase in oxidative decomposition current was not seen even when the potential was raised to about 5 V vs. Li/Li⁺.

### [Fabrication of Nonaqueous Electrolyte Secondary Battery]

The positive electrode and the negative electrode prepared as described above were opposed to each other via a polyethylene separator and were wound to form a wound electrode assembly. In a dry box having an argon atmosphere, the wound electrode assembly and the electrolytic solution were sealed in a battery can, and a cylindrical nonaqueous electrolyte secondary battery of Experiment Example 1 was fabricated. The steps for assembling the cylindrical nonaqueous electrolyte secondary battery, and the battery configuration will be described in detail later.

### EXPERIMENTAL EXAMPLE 2

In Experiment Example 2, a nonaqueous electrolytic solution was prepared in the same manner as in Experiment Example 1, except that the CHB used as the aromatic compound in the nonaqueous electrolytic solution of Experiment Example 1 was replaced by 3-phenylpropyl acetate (PPA). The potential scanning test was performed in the same manner as in Experiment Example 1, and the oxidative decomposition potential for PPA was found to be about 4.8 V vs. Li/Li⁺. A nonaqueous electrolyte secondary battery of Experiment Example 2 was fabricated in the same manner as in Experiment Example 1, except that the electrolytic solution described above was used.

### EXPERIMENTAL EXAMPLE 3

In Experiment Example 3, a nonaqueous electrolyte secondary battery of Experiment Example 3 was fabricated in the same manner as in Experiment Example 1, except that the aromatic compound used in the nonaqueous electrolytic solution of Experiment Example 1 was excluded.

### EXPERIMENTAL EXAMPLE 4

In Experiment Example 4, a nonaqueous electrolyte secondary battery of Experiment Example 4 was fabricated in the same manner as in Experiment Example 1, except that the positive electrode active material used in the positive electrode plate in Experiment Example 1 was replaced by lithium nickel cobalt manganese composite oxide having no deposits of erbium oxyhydroxide on its surface.

### EXPERIMENTAL EXAMPLE 5

In Experiment Example 5, a nonaqueous electrolyte secondary battery of Experiment Example 5 was fabricated in the same manner as in Experiment Example 2, except that the positive electrode active material used in the positive electrode plate in Experiment Example 2 was replaced by lithium nickel cobalt manganese composite oxide having no deposits of erbium oxyhydroxide on its surface.

### Battery Configuration

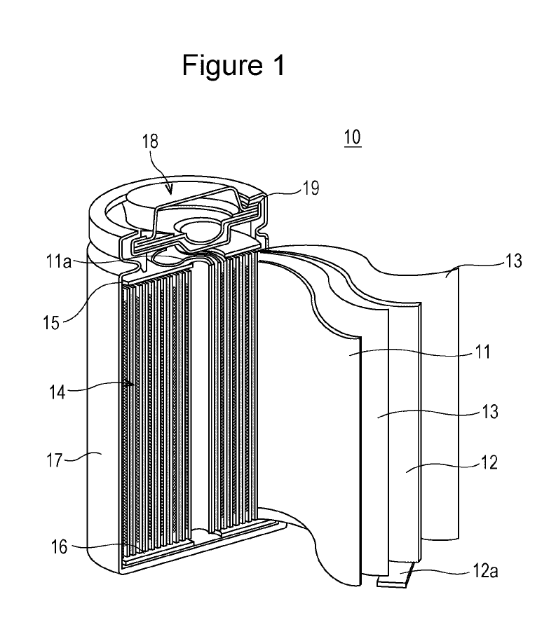

Here, the configuration of a cylindrical nonaqueous electrolyte secondary battery 10 that is common to Experiment Examples 1 to 5 will be described with reference to FIG. 1. The cylindrical nonaqueous electrolyte secondary battery 10 includes a wound electrode assembly 14 in which a positive electrode 11 and a negative electrode 12 are wound via separators 13. Insulating plates 15 and 16 are disposed on and under the wound electrode assembly 14, and the wound electrode assembly 14 is accommodated in a cylindrical battery case 17 made of steel which also serves as a negative electrode terminal. A negative electrode current collector tab 12a of the negative electrode 12 is welded to the inner bottom of the battery case 17, while a positive electrode current collector tab 11a of the positive electrode 11 is welded to a bottom plate of a current-interrupting sealer 18 which includes a safety device.

The nonaqueous electrolytic solution is poured into the battery case 17, and the electrode assembly is impregnated with the solution in vacuum. The current-interrupting sealer 18 is fixed with a gasket 19 which crimps the periphery of the sealer to the edge of the opening of the battery case 17. The cylindrical nonaqueous electrolyte secondary battery 10 with the configuration described above is common to Experiment Examples 1 to 5, and has an 18650 size (diameter 18 mm, length 65 mm) and a rated capacity of 1300 mAh at a charge cutoff voltage of 4.2 V and a discharge cutoff voltage of 2.5 V.

### [Constant Voltage Continuous Charging Storage Test]

The nonaqueous electrolyte secondary batteries of Experiment Examples 1 to 5 fabricated as described above were analyzed to measure the increase in internal resistance after storage during constant voltage continuous charging relative to before the storage in the following manner. First, the nonaqueous electrolyte secondary batteries of Experiment Examples 1 to 5 were tested immediately after their fabrication by a four-terminal method at room temperature and at an alternating current of 1 khz frequency to determine the internal resistance of the batteries before storage during constant voltage continuous charging.

Next, the nonaqueous electrolyte secondary batteries of Experiment Examples 1 to 5 were each allowed to stand in a thermostatic chamber at 60° C. for 3 hours and were thereafter charged at a constant charging current of 450 mA until the battery voltage reached 4.2 V. After the battery voltage reached 4.2 V, the batteries were continuously charged at a constant voltage of 4.2 V for 24 hours. Thereafter, the nonaqueous electrolyte secondary batteries of Experiment Examples 1 to 5 were discharged at a constant discharging current of 450 mA until the battery voltage reached 2.5 V and were cooled to room temperature. The batteries were then tested by a four-terminal method at an alternating current of 1 khz frequency to determine the internal resistance of the batteries after the storage during constant voltage continuous charging.

Based on the values obtained by the measurements, the increase in internal resistance of the batteries of Experiment Examples 1, 2, 4 and 5 relative to before the storage during constant voltage continuous charging was determined. The results were expressed as values relative to the increase in internal resistance of the battery of Experiment Example 3 taken as 100%. The results are described in Table 1.

TABLE 1

| | | | Increase in internal |
|---|---|---|---|
| | Deposits of rare | Aromatic | resistance (relative |
| | earth compound | compound* | values) |
| Experiment | Present | CHB | 88 |
| Example 1 | | | |
| Experiment | Present | PPA | 57 |
| Example 2 | | | |
| Experiment | Present | None | 100 |
| Example 3 | | | |
| Experiment | Absent | CHB | 131 |
| Example 4 | | | |
| Experiment | Absent | PPA | 204 |
| Example 5 | | | |

*CHB: cyclohexylbenzene PPA: 3-phenylpropyl acetate

As evident from Table 1, the nonaqueous electrolyte secondary batteries of Experiment Examples 1 and 2 were demonstrated to suppress the increase in internal resistance after the storage during constant voltage continuous charging to a greater degree than by the nonaqueous electrolyte secondary battery of Experiment Example 3. In Experiment Example 3, the nonaqueous electrolytic solution did not contain CHB or PPA and the nonaqueous electrolyte secondary battery only had a positive electrode which included positive electrode active material particles having a rare earth compound attached to the surface. In this case in which the battery only has a positive electrode active material coated with deposits of a rare earth compound, the decomposition of the nonaqueous electrolytic solution takes place continuously on the surface of the positive electrode active material and consequently a significant increase in internal resistance is caused.

By covering the surface of positive electrode active material particles with a rare earth compound, the deposits prevent the direct contact between the positive electrode active material particles and the nonaqueous electrolytic solution. However, this approach alone cannot prevent a significant increase in internal resistance probably because the decomposition of the nonaqueous electrolytic solution occurs continuously in the course of the storage during constant voltage continuous charging at regions free from the deposits of the rare earth compound.

In the nonaqueous electrolyte secondary batteries of Experiment Examples 4 and 5 in which the addition of CHB or PPA as the aromatic compound alone was satisfied, a marked increase in internal resistance was caused probably because the aromatic compound was decomposed in the course of the storage during constant voltage continuous charging to form a polymer as a resistant component on the surface of the positive electrode active material particles. While an aromatic compound is oxidatively decomposed inevitably when the oxidative decomposition potential for the aromatic compound is lower than the positive electrode potential in a charged state, the decomposition reaction occurs to a slight degree even in the case where the oxidative decomposition potential for the aromatic compound is higher than the positive electrode potential in a charged state. Thus, the increase in internal resistance that occurs when an aromatic compound is added to a nonaqueous electrolytic solution is a problem encountered even in the case where the oxidative decomposition potential for the aromatic compound is higher than the positive electrode potential in a charged state.

Accordingly, it is clear that the effects of the nonaqueous electrolyte secondary batteries of Experiment Examples 1 and 2 in suppressing the increase in internal resistance after the storage during constant voltage continuous charging are produced specifically only when the positive electrode that includes a positive electrode active material coated with deposits of a rare earth compound is used in combination with the nonaqueous electrolytic solution including an aromatic compound such as any of those described above.

In the nonaqueous electrolyte secondary batteries of Experiment Examples 1 and 2, the rare earth compound attached to the surface of the positive electrode active material particles is reacted with the aromatic compound in an initial stage of the storage during constant voltage continuous charging to form a uniform protective film on the surface of the positive electrode active material particles. As a result, the film suppresses the decomposition of the nonaqueous electrolytic solution in the later stage of the storage during constant voltage continuous charging. This is probably the mechanism which suppresses the increase in internal resistance after the storage during constant voltage continuous charging.

Detailed reasons as to why such a quality protective film is formed in the nonaqueous electrolyte secondary batteries of Experiment Examples 1 and 2 are still unclear but are considered as follows. Rare earth elements have 4f orbital electrons. When the surface of positive electrode active material particles is covered with deposits of a rare earth compound, an aromatic compound having a π electron orbital is selectively attracted toward the positive electrode. Thus, the charging reaction is considered to be accompanied by the reaction of the rare earth element that is dispersed uniformly, with the aromatic compound to form a quality film uniformly on the surface of the positive electrode active material particles.

While Experiment Examples 1 to 3 illustrate erbium oxyhydroxide as the rare earth compound attached to the surface of positive electrode active material particles, other rare earth compounds are also usable. Preferred compounds are rare earth hydroxides, rare earth oxyhydroxides and rare earth oxides. In particular, the aforementioned effects are produced more markedly by using rare earth hydroxides or rare earth oxyhydroxides.

A rare earth hydroxide attached to the surface of positive electrode active material particles is converted into an oxyhydroxide or an oxide by heat treatment. In general, the conversion of a rare earth hydroxide or oxyhydroxide into an oxide stably takes place at a temperature of 500° C. or above. However, heat treatment at such a temperature causes part of the rare earth compound attached to the surface to be diffused to the inside of the positive electrode active material and consequently changes in the crystal structure of the surface of the positive electrode active material may not be suppressed effectively. It is therefore preferable that the rare earth compounds do not include rare earth oxides. The rare earth compounds may include a proportion of other types of compounds such as rare earth carbonate compounds and rare earth phosphate compounds.

Examples of the rare earth elements present in the rare earth compounds include yttrium, lanthanum, cerium, neodymium, samarium, europium, gadolinium, cerium, terbium, dysprosium, holmium, erbium, thulium, ytterbium and lutetium, with neodymium, samarium and erbium being preferable. Neodymium compounds, samarium compounds and erbium compounds are preferable because they have a smaller median particle diameter and tend to be precipitated more uniformly on the surface of the positive electrode active material particles than other types of the rare earth compounds.

Specific examples of the rare earth compounds include neodymium hydroxide, neodymium oxyhydroxide, samarium hydroxide, samarium oxyhydroxide, erbium hydroxide and erbium oxyhydroxide. Because lanthanum is less expensive than other rare earth elements, the use of lanthanum hydroxide or lanthanum oxyhydroxide as the rare earth compound is advantageous in that the cost for producing the positive electrodes may be reduced.

The median grain diameter (D₅₀) of the rare earth compound is desirably 1 nm to 100 nm. If the median particle diameter of the rare earth compound exceeds 100 nm, the rare earth compound has so large a grain diameter relative to the grain diameter of the positive electrode active material particles that the rare earth compound fails to cover densely the surface of the positive electrode active material particles. Consequently, the positive electrode active material particles have an increased area of regions that are placed in direct contact with the nonaqueous electrolyte and reductive decomposition products thereof. This facilitates the oxidative decomposition of the nonaqueous electrolyte and reductive decomposition products thereof, resulting in a decrease in charging/discharging characteristics.

If the median particle diameter of the rare earth compound is less than 1 nm, the rare earth compound covers the surface of the positive electrode active material particles so densely that the positive electrode active material particles reduce their performance in the insertion and release of lithium ions through the surface to cause a decrease in charging/discharging characteristics. In view of these facts, the median grain diameter of the rare earth compound is more preferably 10 nm to 50 nm.

The rare earth compound such as erbium oxyhydroxide may be attached to the positive electrode active material particles by, for example, mixing an aqueous solution of a rare earth salt with a solution in which the positive electrode active material particles are dispersed. Alternatively, the attachment may be accomplished by spraying an aqueous solution of a rare earth salt to the positive electrode active material particles while mixing the particles, followed by drying. In particular, a preferred method is to mix an aqueous solution of a rare earth salt such as an erbium salt with a solution in which the positive electrode active material particles are dispersed. The reason for this is because this method allows the rare earth compound to be attached to the surface of the positive electrode active material particles in a more uniformly dispersed fashion. In the method, it is preferable that the pH of the dispersion solution of the positive electrode active material particles be controlled to be constant. In particular, the pH is preferably controlled to 6 to 10 in order to ensure that fine particles having a size of 1 to 100 nm will be precipitated in a uniformly dispersed fashion on the surface of the positive electrode active material particles. If the pH is less than 6, the transition metals in the positive electrode active material particles may be dissolved out. If, on the other hand, the pH exceeds 10, the rare earth compound may be segregated.

In the lithium transition metal oxide as the positive electrode active material, the ratio of the rare earth element to the total moles of the transition metals is desirably 0.003 mol % to 0.25 mol %. If the ratio is less than 0.003 mol %, the attachment of the rare earth compound may not produce sufficient effects. If, on the other hand, the ratio exceeds 0.25 mol %, the surface of the positive electrode active material particles decreases lithium ion permeability and the battery characteristics are deteriorated.

The lithium transition metal oxide as the positive electrode active material preferably includes Li, Ni and Mn and has a layered structure. More preferably, the lithium transition metal oxide is an oxide represented by the general formula Li₁₊ₓNiₐMn_{b}Co_{c}O_{2+d} (wherein x, a, b, c and d satisfy x+a+b+c=1, 0<x≦0.2, a≧b, a≧c, 0<c/(a+b)<0.65, 1.0≦a/b≦3.0, and −0.1≦d≦0.1).

In the lithium nickel cobalt manganese composite oxide represented by the above general formula, the compositional ratio c of Co, the compositional ratio a of Ni and the compositional ratio b of Mn satisfy 0<c/(a+b)<0.65. The purpose of this condition is to reduce the costs of the raw materials for the positive electrode active material by decreasing the proportion of Co. Further, in the lithium nickel cobalt manganese composite oxide represented by the above general formula, the compositional ratio a of Ni and the compositional ratio b of Mn satisfy 1.0≦a/b≦3.0. The purpose of this condition is to prevent disadvantages in the safety design of the batteries because an increase in the proportion of Ni to such an extent that the value of a/b exceeds 3.0 leads to a decrease in the thermal stability of the lithium nickel cobalt manganese composite oxide and consequently the peak maximum of heat generation is reached at a lower temperature. If, on the other hand, the proportion of Mn is increased to such an extent that the value of a/b falls to below 1.0, an impurity layer is formed easily and the battery capacity is decreased. In view of these facts, it is more preferable that the oxide satisfy 1.0≦a/b≦2.0, and in particular 1.0≦a/b≦1.8.

In the lithium nickel cobalt manganese composite oxide represented by the above general formula, x in the compositional ratio (1+x) of Li advantageously satisfies 0<x≦0.2. When 0<x, the output characteristics of the batteries are enhanced. If x>0.2, on the other hand, an increased amount of the alkali component remains on the surface of the lithium nickel cobalt manganese composite oxide and the slurry tends to be gelled during the battery production steps; further, the amount of the transition metals involved in the redox reaction is decreased and the positive electrode capacity is decreased. In view of these facts, the oxide more preferably satisfies 0.05≦x≦0.15.

Additionally, in the lithium nickel cobalt manganese composite oxide represented by the above general formula, d in the compositional ratio (2+d) of O satisfies −0.1≦d≦0.1. The purpose of this condition is to prevent defects in the crystal structure as a result of the lithium nickel cobalt manganese composite oxide being oxygen-deficient or oxygen-overenriched.

The lithium transition metal oxide as the positive electrode active material may contain at least one selected from the group consisting of boron (B), fluorine (F), magnesium (Mg), aluminum (Al), titanium (Ti), chromium (Cr), vanadium (V), iron (Fe), copper (Cu), zinc (Zn), niobium (Nb), molybdenum (Mo), zirconium (Zr), tin (Sn), tungsten (W), sodium (Na) and potassium (K).

Regarding the aromatic compounds, it is usually preferable to use one having an oxidative decomposition potential of 4.2 to 5.0 V vs. Li/Li⁺, and more preferably 4.4 to 4.9 V vs. Li/Li⁺. Here, the oxidative decomposition potential means the potential which causes the onset of a sharp increase in the oxidation current (induces rapid oxidative decomposition) in a potential scanning test at 25° C. using a platinum electrode as the working electrode. If the oxidative decomposition potential is excessively high relative to the positive electrode potential in a fully charged state of the battery, overcharging is not prevented effectively. On the other hand, any excessively low oxidative decomposition potential may cause a significant decrease in the battery characteristics during the use of batteries under normal conditions.

Aromatic compounds other than cyclohexylbenzene (CHB) and 3-phenylpropyl acetate (PPA) are also usable as the aromatic compounds. Examples of such additional aromatic compounds include those aromatic compounds used as known overcharging inhibitors. Specific examples of the additional aromatic compounds include biphenyls, alkylbiphenyls such as 2-methylbiphenyl, terphenyls, partially hydrogenated terphenyls, benzene derivatives such as naphthalene, toluene, anisole, cyclopentylbenzene, t-butylbenzene and t-amylbenzene, phenyl ether derivatives such as phenyl propionate, halides of these compounds, and halogenated benzenes such as fluorobenzene and chlorobenzene. These may be used singly, or two or more may be used in combination.

The content of the aromatic compound is preferably 0.5 mass % to 10 mass % relative to the whole of the nonaqueous solvent. Any excessively high content causes adverse effects on battery characteristics such as a decrease in the conductivity or the oxidation resistance of the electrolytic solution. If, on the other hand, the content is excessively low, the increase in internal resistance after the storage during constant voltage continuous charging is not suppressed sufficiently effectively.

In the nonaqueous electrolyte secondary battery of the invention, the negative electrode active material used in the negative electrode is not particularly limited as long as the material is capable of reversible insertion and release of lithium. Examples include carbon materials, metal or alloy materials which may be alloyed with lithium, and metal oxides. From the viewpoint of material cost, the negative electrode active material is preferably a carbon material such as natural graphite, artificial graphite, mesophase pitch carbon fibers (MCF), mesocarbon microbeads (MCMB), coke, hard carbon, fullerene or carbon nanotubes. In particular, a carbon material obtained by coating a graphite material with low-crystalline carbon is preferably used as the negative electrode active material in order to enhance high-rate charging/discharging characteristics.

Examples of the nonaqueous solvents in the nonaqueous electrolytes include cyclic carbonate esters such as ethylene carbonate (EC), propylene carbonate (PC), butylene carbonate (BC) and ethyl methyl carbonate (EMC); fluorinated cyclic carbonate esters such as fluoroethylene carbonate (FEC); lactones (cyclic carboxylate esters) such as γ-butyrolactone (γ-BL) and γ-valerolactone (γ-VL); chain carbonate esters such as dimethyl carbonate (DMC), ethyl methyl carbonate (EMC), diethyl carbonate (DEC), methyl propyl carbonate (MPC) and dibutyl carbonate (DBC); fluorinated chain carbonate esters such as fluorinated methyl propionate (FMP) and fluorinated ethyl methyl carbonate (F-EMC); chain carboxylate esters such as methyl pivalate, ethyl pivalate, methyl isobutyrate and methyl propionate; amide compounds such as N,N′-dimethylformamide and N-methyloxazolidinone; sulfur compounds such as sulfolane; and ambient temperature molten salts such as 1-ethyl-3-methylimidazolium tetrafluoroborate. Two or more of these solvents may be used as a mixture.

The electrolyte salt dissolved in the nonaqueous solvent to form the nonaqueous electrolyte may be a lithium salt commonly used as an electrolyte salt in nonaqueous electrolyte secondary batteries. For example, the lithium salt may be one or a mixture of lithium hexafluorophosphate (LiPF₆), LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀ and Li₂B₁₂Cl₁₂. In particular, LiPF₆ is preferably used in order to increase the high-rate charging/discharging characteristics and the durability of the nonaqueous electrolyte secondary batteries. Further, LiPF₆ may be used in combination with a lithium slat having an oxalate complex as the anion (such as LiBOB).

To the nonaqueous electrolyte, an electrode-stabilizing compound may be added, with examples including vinylene carbonate (VC), adiponitrile (AdpCN), vinyl ethyl carbonate (VEC), succinic anhydride (SUCAH), maleic anhydride (MAAH), glycolic anhydride, ethylene sulfite (ES), divinyl sulfone (VS), vinyl acetate (VA), vinyl pivalate (VP) and catechol carbonate. Two or more of these compounds may be used appropriately as a mixture.

In the nonaqueous electrolyte secondary battery of the invention, the separators disposed between the positive electrode and the negative electrode are not particularly limited as long as they are made of a material which may prevent short circuits due to a contact between the positive electrode and the negative electrode and may be impregnated with the nonaqueous electrolytic solution to allow lithium ions to pass therethrough. Examples include polypropylene separators, polyethylene separators and polypropylene-polyethylene multilayer separators.

### INDUSTRIAL APPLICABILITY

For example, flat nonaqueous electrolyte secondary batteries according to an aspect of the invention may be applied to power supplies for driving mobile information terminals such as cellular phones, notebook computers and tablet computers, in particular, to such applications requiring a high energy density. Further, the use is expected to expand to high-output applications such as electric vehicles (EVs), hybrid electric vehicles (HEVs, PHEVs) and electric tools.

### REFERENCE SIGNS LIST

10 . . . CYLINDRICAL NONAQUEOUS ELECTROLYTE SECONDARY BATTERY

11 . . . POSITIVE ELECTRODE

11a . . . POSITIVE ELECTRODE CURRENT COLLECTOR TAB

12 . . . NEGATIVE ELECTRODE

12a . . . NEGATIVE ELECTRODE CURRENT COLLECTOR TAB

13 . . . SEPARATOR

14 . . . WOUND ELECTRODE ASSEMBLY

15 . . . INSULATING PLATE

17 . . . BATTERY CASE

18 . . . CURRENT-INTERRUPTING SEALER

19 . . . GASKET

1. A nonaqueous electrolyte secondary battery comprising a positive electrode, a negative electrode and a nonaqueous electrolytic solution, the positive electrode including a positive electrode active material containing a lithium transition metal oxide having a rare earth compound attached on the surface,
the nonaqueous electrolytic solution including an aromatic compound having an oxidative decomposition potential in the range of 4.2 to 5.0 V vs. Li/Li⁺.

2. The nonaqueous electrolyte secondary battery according to claim 1, wherein the rare earth compound is a rare earth hydroxide, a rare earth oxyhydroxide or a rare earth oxide.

3. The nonaqueous electrolyte secondary battery according to claim 1, wherein the rare earth element is at least one selected from neodymium, samarium and erbium.

4. The nonaqueous electrolyte secondary battery according to claim 1, wherein the aromatic compound is at least one selected from cyclohexylbenzene, 3-phenylpropyl acetate, phenyl propionate, biphenyls, 2-methylbiphenyl, terphenyls, partially hydrogenated terphenyls, naphthalene, anisole, cyclopentylbenzene, toluene, t-butylbenzene, t-amylbenzene, halides of these compounds, fluorobenzene and chlorobenzene.

5. The nonaqueous electrolyte secondary battery according to claim 4, wherein the aromatic compound is at least one selected from cyclohexylbenzene and 3-phenylpropyl acetate.

6. The nonaqueous electrolyte secondary battery according to claim 1, wherein the content of the aromatic compound is 0.5 mass % to 10 mass % relative to the whole of a nonaqueous solvent.

7. The nonaqueous electrolyte secondary battery according to claim 1, wherein the lithium transition metal oxide includes Li, Ni and Mn and has a layered structure.

8. The nonaqueous electrolyte secondary battery according to claim 1, wherein the lithium transition metal oxide is a compound represented by the general formula Li₁₊ₓNiₐMn_{b}Co_{c}O_{2+d} (wherein x, a, b, c and d satisfy x+a+b+c=1, 0<x≦0.2, a≧b, a≧c, 0<c/(a+b)<0.65, 1.0≦a/b≦3.0, and −0.1≦d≦0.1).
